(19) United States
(12) Patent Application Publication
(10) Pub. No.: US 2010/0057528 A1
(43) Pub. Date: Mar. 4, 2010

(54) METHODS FOR RENDERING ADVERTISEMENT MESSAGES BY THE USE OF A MOBILE COMMUNICATION DEVICE

(76) Inventor: Yan Pan, (US)

Correspondence Address: Yang Pan;Intellectual Power Pte Ltd, No. 14 Robinson Road #06-01,, Far East Finance Building, Singapore, 048545, SG

(21) Appl. No.: 12/202,222

(22) Filed: Aug. 30, 2008

(51) Int. Cl. G06Q 30/00; G01C 21/00

(52) U.S. Cl. 705/10; 701/213; 705/14.49

(57) ABSTRACT

A method is disclosed for rendering advertisement messages to a user. A display screen of a mobile device is used to present an advertisement message during and after a voice communication. The user may decide to view the message or to ignore the message after the voice communication is terminated. There is no user input action is required if the user decides to ignore the message. A plurality of user selectable items is then displayed on the screen accompanied by the displayed message if the user selects the message for further review. The user selectable items may include at least one icon representing a folder contains other advertisement messages which may intrigue the user. In another aspect of the present invention, contents of the voice communication is analyzed by converting words used in the communication into a text form of the words and then comparing the words with a list of words in a file representing commercial interest of an average user. The message is rendered based upon the determined user's commercial interests.

### CROSS-REFERENCE TO RELATED APPLICATIONS

Not applicable.

### BACKGROUND

1. Field of Invention

This invention relates generally to advertising. More specifically, the invention relates to methods and systems for providing advertisements by the use of mobile communication devices.

2 Description of Prior Art

To provide information and communication services to various users, mobile devices with computing and communication means are widely used today. Many of these mobile devices are kept in a functioning state even when the user is not using the device in order to keep the device in touch with the communication network. Many electronic devices simply display an idle screen while the device is not being used. Many mobile devices display a blanket screen to conserve energy provided by a battery. A typical idle screen for a mobile computing and communication device may include such information as radio signal strength, battery charge level, current date, time of day.

Such displays provide no or little information to the user who, however, has to glance at the display whenever he/she operates the device. It would be desirable to display advertisement messages so that it is nearly guaranteed that the user sees the messages.

U.S. Pat. Nos. 5,913,040, 6,317,789, 6,539,429 to Rekey et al disclosed prior arts to utilize idle screen of a mobile device to display advertisement messages, which are delivered to the user's device without user's notification. The messages are displayed preferably as a screen saver. U.S. Pat. No. 6,363,419 to Martin; Jr. et al disclosed a method to display useful or commercial information on an idle screen. The idle content screen is switched to a default display screen when a user's input action is received. The default display screen is the gateway for the user to navigate to various application menus of the mobile device. US patent application 2004/0077340 by Forsyth and the application 2006/0156256 by Lee disclosed similar arts to use idle screens for displaying commercial information with the user's programmability on the displayed contents. In U.S. Pat. No. 7,369,864 to Vaananen, an art is disclosed by using of electronic short messaging method to deliver advertisement messages. The user is shown the message automatically, and he or she may delete it or receive further information on it with one single press of a dedicated key.

There are two disadvantages associated with using an idle screen for presenting an advertisement message. First, a user may not in a mode to view the message displayed on the idle screen when he or she receives a call. The situation becomes worse if the user needs to apply additional input actions to get rid of messages displayed and to receive the call. Further, the message displayed using the idle screen may consume additional power from the battery, in particularly, if the displayed messages include colorful pictures or multimedia messages. Although significant progress has been made with regards to the battery technology in recent years, the reduction of power consumption continues to be a key challenge for mobile devices. The utilization rate of a mobile device is low for a typical user. It wastes power if the displayed messages are not viewed by the user while being put into the user's pocket or a handbag.

Accordingly, it is an object of the present invention to provide a method for rendering advertisement messages during and after a voice communication. The user notices the message immediately after the termination of the voice communication. There is no required user action if the user is not interested in the message and the message is deleted after a predetermined period of time. If the message is indeed selected by the user for a further review, more user selectable icons are then displayed on the screen for the user's selection of the next level of detailed information.

It is another object of the present invention that the message rendered is based upon contents of the voice communication, from which the user's commercial interests may be derived.

It is yet another object of the present invention that the message rendered is based upon a combination of the content of the voice communication and a current location of the user.

It is still another object of the present invention that the user's commercial interests are determined by comparing the words used in the voice communication with the ones included in a file representing a typical user's commercial interests. The words used are ranked based upon the frequency of appearance and the user's commercial interests may be derived. By doing so, the advertisement broker operating an advertisement server accesses only the highest ranked words but not sentences. Thus a targeted advertisement can be rendered without risking exposing a user's privacy.

### SUMMARY OF THE INVENTION

To more effectively use the display screen of mobile devices, the present invention introduces methods for rendering targeted advertisement messages to a user during and after a voice communication. The device displays an advertisement message when a user is being engaged in a voice communication. The user views the message immediately after the termination of the voice communication. No additional user input action is required if the user is not interested in the message.

In one embodiment, the message is displayed after the device receives a signal that the user is engaged in a voice communication or a “call”. The user typically clicks a button related to the termination of the call after the completion of the call. It is likely that the user notifies the message displayed and he or she may decide to leave the message un-touched or to view the message further. In the present invention, a touch-screen type of display is used as an exemplary case for illustration. In the present embodiment, the user touches the screen displayed with the message after the termination of the call if the advertisement message intrigues him or her. The next level of detailed information is then displayed after receiving the user's input action. Alternatively, a plurality of user selectable items represented by icons is displayed for the user's selection to view the information with further details. In another aspect of the invention, the displayed icons may include one specific icon representing other advertisement messages in the folder. If the user selects the icon, a plurality of advertisement messages is displayed on the screen for the user's selection and review.

In another aspect of the present invention, the content of the voice communication is analyzed by a software program embedded in the device. The words involved in the communication are collected and converted into text form by using of a software module for the voice recognition. The collected words are compared with a list of words in a stored file representing commercial interests of a typical user. A successful match event is established if a word from the voice communication is matched with a word in the file. The words are then ranked based upon the frequency of the successful matches. A user's commercial interests are determined based upon such a ranking process. A targeted advertisement message is then displayed after the call is terminated. It should be noted that there is not always a commercial interest of a user is revealed through a voice communication. A targeted advertisement message can still be displayed based upon the user's profile and the location of the user etc.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a server used by an advertisement broker receiving real time advertisement messages from advertisers and sending to a plurality of mobile devices through communication networks.

FIG. 2 is a schematic diagram of a mobile communication device, an “advertisement message manager” (software module) is used to control the operations of rendering advertisement messages and a “key word analyzer” (software module) including a voice recognition unit and a data file named “key word library” is used to determine a user's commercial interests based upon contents of the voice communication.

FIG. 3 is a schematic diagram of a series of display screens showing the changes from a default screen for the mobile device in a calling status to a screen with a displayed message and further to a screen with more user selectable icons for the next level of detailed information.

FIG. 4 is a flow diagram of an embodiment for rendering an advertisement message to a display screen of the mobile device during and after the voice communication.

FIG. 5 is a schematic diagram of a series of display screens showing the changes from a default screen for the mobile device in a calling status to a screen with a displayed message and further to a screen with more user selectable icons for the next level of detailed information and an icon for other advertisement messages.

FIG. 6 is a flow diagram of another embodiment for rendering advertisement messages to a display screen of the mobile device during and after the voice communication, wherein the displayed messages include an icon for other advertisement messages.

FIG. 7 is a flow diagram of still another embodiment for rendering advertisement messages to a display screen of the mobile device during and after the voice communication, wherein the displayed message is determined based upon the analysis of contents of the voice communication.

FIG. 8 is a flow diagram of the “key word analyzer” determining a user's commercial interest by comparing words extracted from the voice communication with a list of words in the “key word library”.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

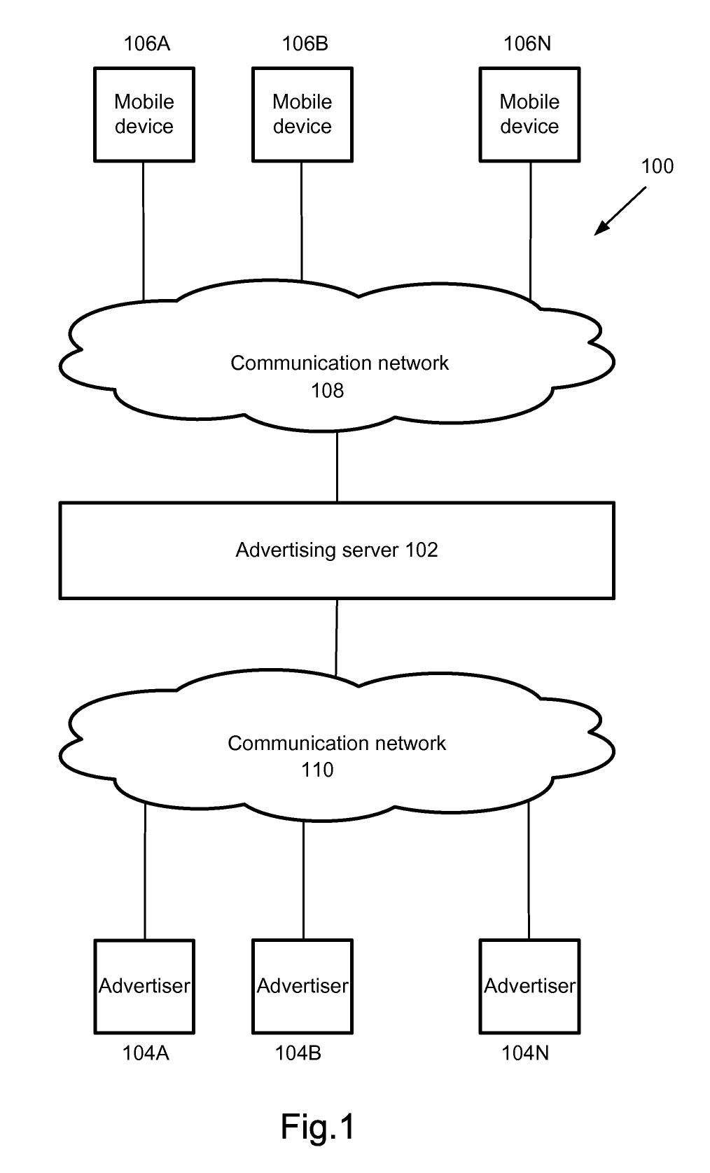

FIG. 1 is a schematic diagram of an exemplary communication system100 for distributing advertisement messages. An advertising server 102 is used by an advertisement broker receiving real time advertisements from advertisers 104 and sending to a plurality of electronic devices 106. The electronic devices 106A, 106B, 106N can take various forms such as, for example, it can be a mobile computing and communication device which a user is carrying with. In various embodiments, each electronic device may communicate with an advertising server 102 through a communication network 108. The communication network can take various forms such as the internet, a W-LAN and other suitable communication networks. A plurality of advertisers 104A, 104B, and 104N may also communicate with the advertising server 102 over a communication network 110. In various embodiments network 108 and 110 may be the same network, however, in various other embodiments, the network 108 and 110 may be different networks. In various embodiments, the advertisers 104A, 104B, 104N may communicate with the advertising server 102 for a number of reasons, including, purchasing advertisement space and uploading advertisement messages. In the present invention, the advertisement messages from the advertisers to the advertising server are updated continuously on a real time base.

It should be noted that system depicted in FIG. 1 shows a single advertising server 102 for ease of illustration purpose only. Various embodiments may use multiple servers in a manner that is either apparent or transparent to the communication system and its users.

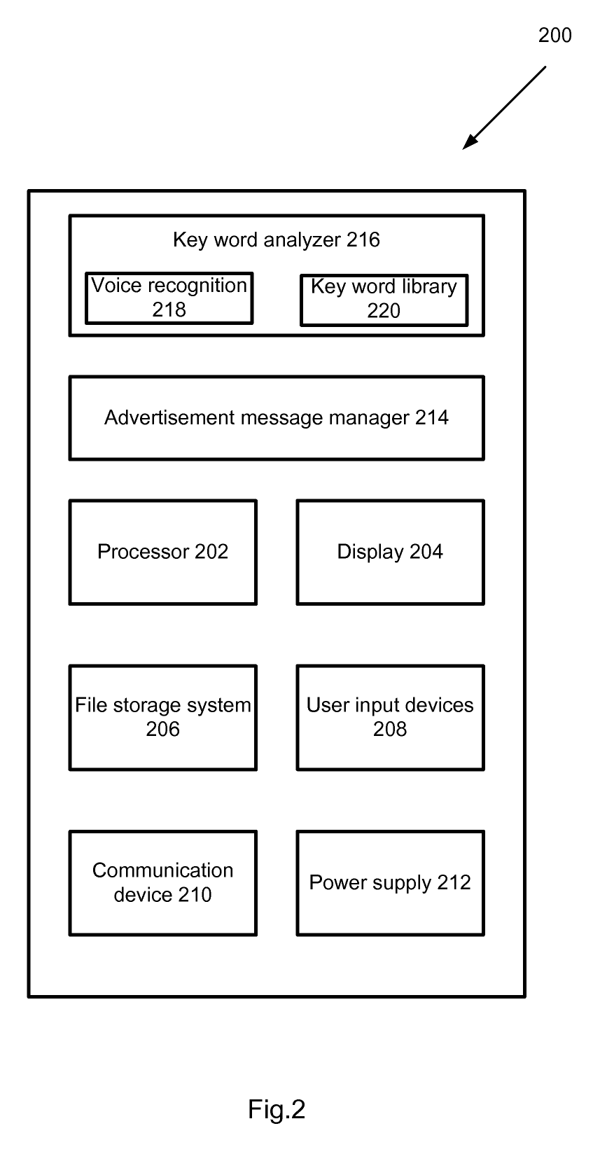

We take a mobile computing and communication device as an exemplary case to illustrate the present invention. As shown in FIG. 2, the mobile device 200 may comprise a processor 202 to control operations of the device, a display screen 204, such as, for example, a Liquid Crystal Display (LCD) screen and a file storage system 206. The file storage system 206 is typically a semiconductor flash memory device or a plurality of flash memory devices or a magnetic storage means as a hard disk driver. The file storage system may also include a cache to improve the data access time. The mobile device 200 further comprises a user input device or devices 208 as keys, touch pads or a rotational user interface as used in iPod from Apple Inc Cupertino Calif. The user input device can be integrated at least partially with the display screen in a specific implementation related to touch-screen type of display. A touch-screen is a display which can detect the location of touches within display area, usually performed either with the human hand or a stylus. The device 200 also includes a communication device module 210 to connect to the communication network. The communication network can take forms as a telephony network or the internet. In one implementation, the mobile device is GSM mobile station. In other implementations, the mobile devices may be a UMTS, WAP, Teldesic, Inmarsat, Iridium, GPRS, CDMA, WCDMA mobile station. The mobile device may be connectable to a wireless internet network. The device is powered by a power supply 212 such as a battery.

A software module “advertisement message manager” 214 is used to control the operations for receiving and displaying advertisement messages delivered from the advertising server. The device being characterized in that, the software module is arranged to identify in coming advertisement messages, store the messages in the file system or display at least portion of messages directly on the display screen. The mobile device may further comprise a Global Positioning System (GPS) (not shown in the figure) to identify its position of a mobile device. Recently, GPS has been developed to the point where they are very inexpensive to implement in a mobile device. The employment of the GPS can assist the server to deliver location-based advertisement messages to the user.

In various embodiments of the invention, advertisements may include text, graphics, video, audio and multimedia messages. It should be appreciated that while advertisement messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computer systems, or other definable concepts or content may be used. Thus although the use of advertisement messages are described herein as examples, other documents such as web pages may be targeted to viewers and displayed in accordance the various embodiments, e.g. as described herein with respect to advertisement messages.

It should be understood that an advertisement message as used herein may comprise audio and/or video signals, static and/or dynamic images, graphics, video, film, or other content that relate to one or more products, services, and/or entities, such as commercial entities. Advertisement messages may also comprise various visual features, including animation, sound etc., and may include text, such as in a text advertisement. Thus, the term “advertisement message” is used herein in its broadest sense to include any content or object intended for observation, use, or consumption by one or more persons for the purpose of marketing or promoting a product or service. While, advertisement messages are used for exemplary purpose, it should be understood that any audio and/or video content, such as television programming, may be used with the systems and methods described herein.

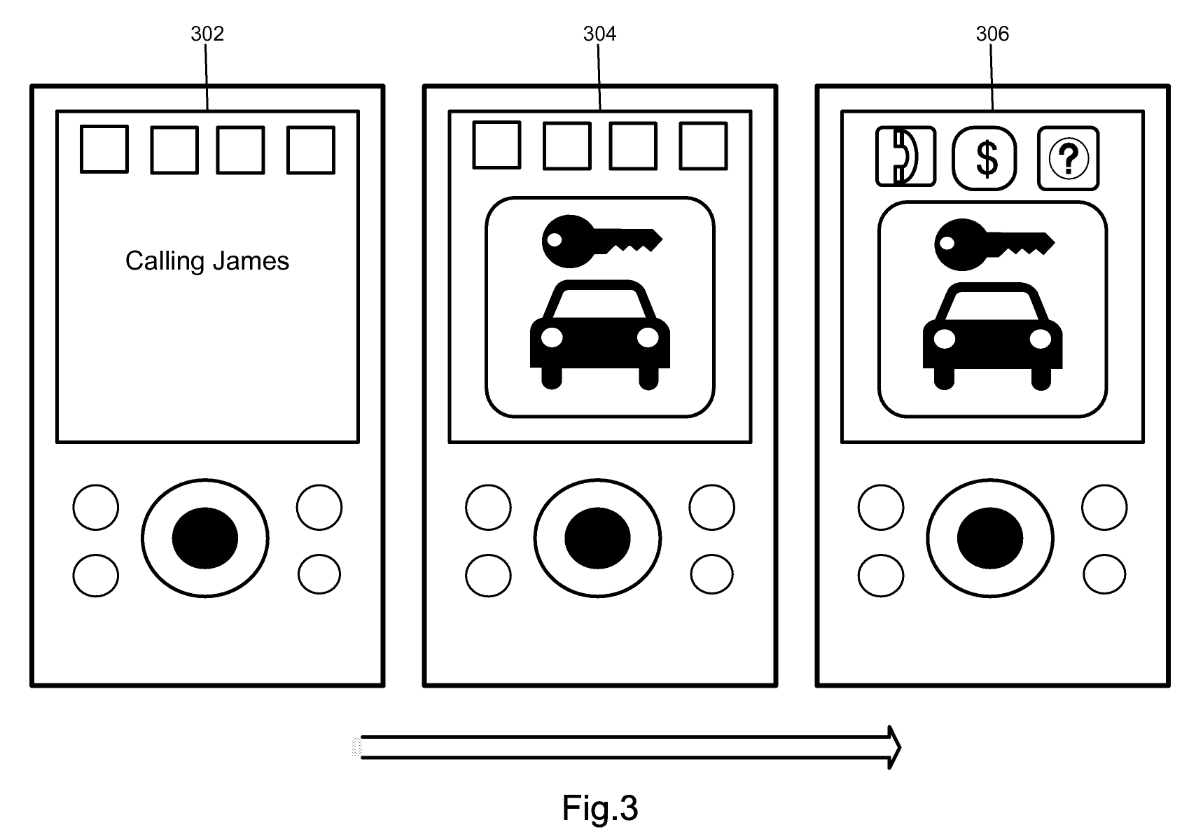

FIG. 3 is a schematic diagram of a series of display screens showing the changes from a default screen for the mobile device in a calling status to a screen with a displayed message and further to a screen with more user selectable icons for the next level of detailed information. An exemplary screen for a mobile device in the “calling” status is shown in 302. The screen is typically showing a calling number or a name of the one in dialogue with the user. The screen may also display a plurality of icons which are used for the default screen for the device leading to various applications. In one embodiment, an advertisement message is displayed replacing the items displayed in the standard “calling” screen as shown in 304. In one aspect of the present invention, the default icons are remained on the screen with displayed message. This arrangement allows the user to access the other applications conveniently after the call is terminated. If the user selects the message for a further review, a plurality of icons is displayed as shown in the message screen 306.

The user may choose one of the icons for receiving more detailed information about the message. A touch-screen type of display is used as an exemplary illustration. After the call is terminated by the user by clicking the button associated with the termination, the user is likely to notice the message on the screen. He or she may choose to ignore the message by simply doing nothing with regards to the message. After a predetermined period of time, the message is deleted if no user input action with regards to the message is received. In case that the user does select the message for further review such as, for example, selects the message by touching the screen of the touch-screen type of display, a plurality of icons for next level of detailed messages is displayed. In 308, exemplary icons are shown including an icon with a symbol representing a phone, an icon with a “$” and an icon with “?”. If the user selects the icon representing a phone, a connection between the user and the advertiser is established. The user may talk to the sale representative of the advertiser for further information without key-in the phone number of the advertiser. If the user selects the icon represented by a “$” symbol, the next screen may present to the user more detailed purchasing information for the products or services. The icon represented by “?” presents to user more product or service information when selected by the user.

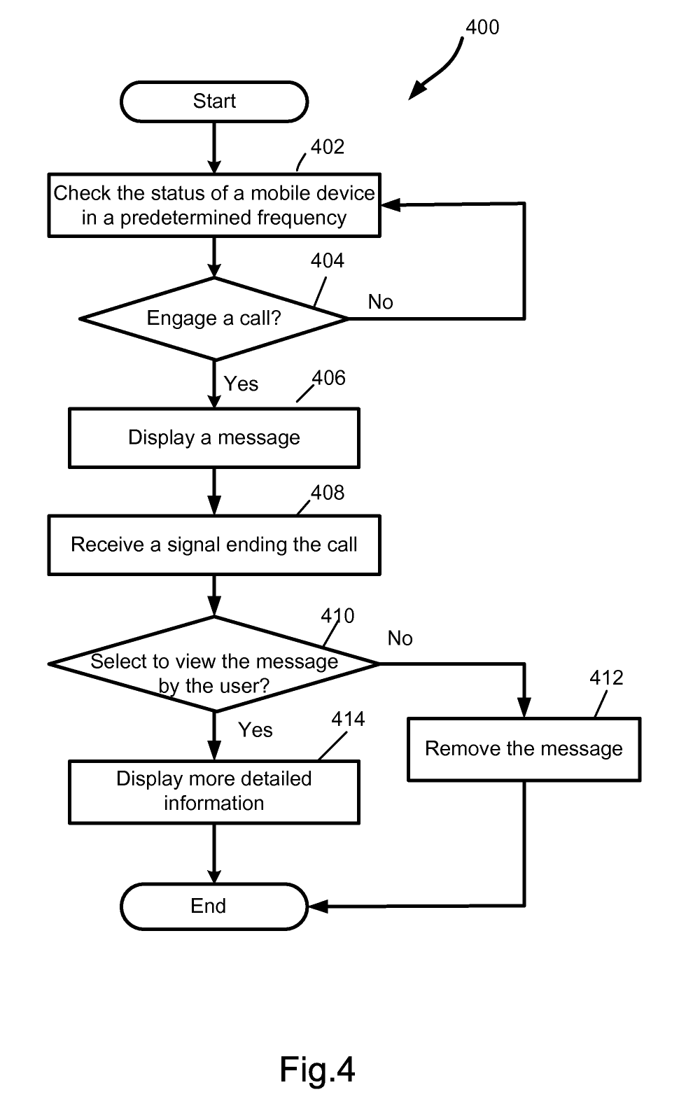

FIG. 4 is a flow diagram of an embodiment for delivering and presenting advertisement messages to a screen of the mobile device during and after the voice communication. A process 400 starts by a step 402; the processor of the mobile device checks the device status in a predetermined frequency. If the processor detects that the device is in a “calling” status at a step 404, an advertisement message is displayed in a step 406. The messages are delivered from the advertising server to the mobile device and are stored in a folder of the file storage system. In a step 408, the call is terminated by the user and a signal associated with the ending the call is received by the processor. The step 410 checks the user's input action. If no user's input action is received, the displayed message is deleted in a step 412 after a predetermined period of time. If the user does select the message, the next level of detailed messages is displayed in a step 414. In an alternative means, a plurality of user selectable items is displayed and the user can select at least one icon for further information.

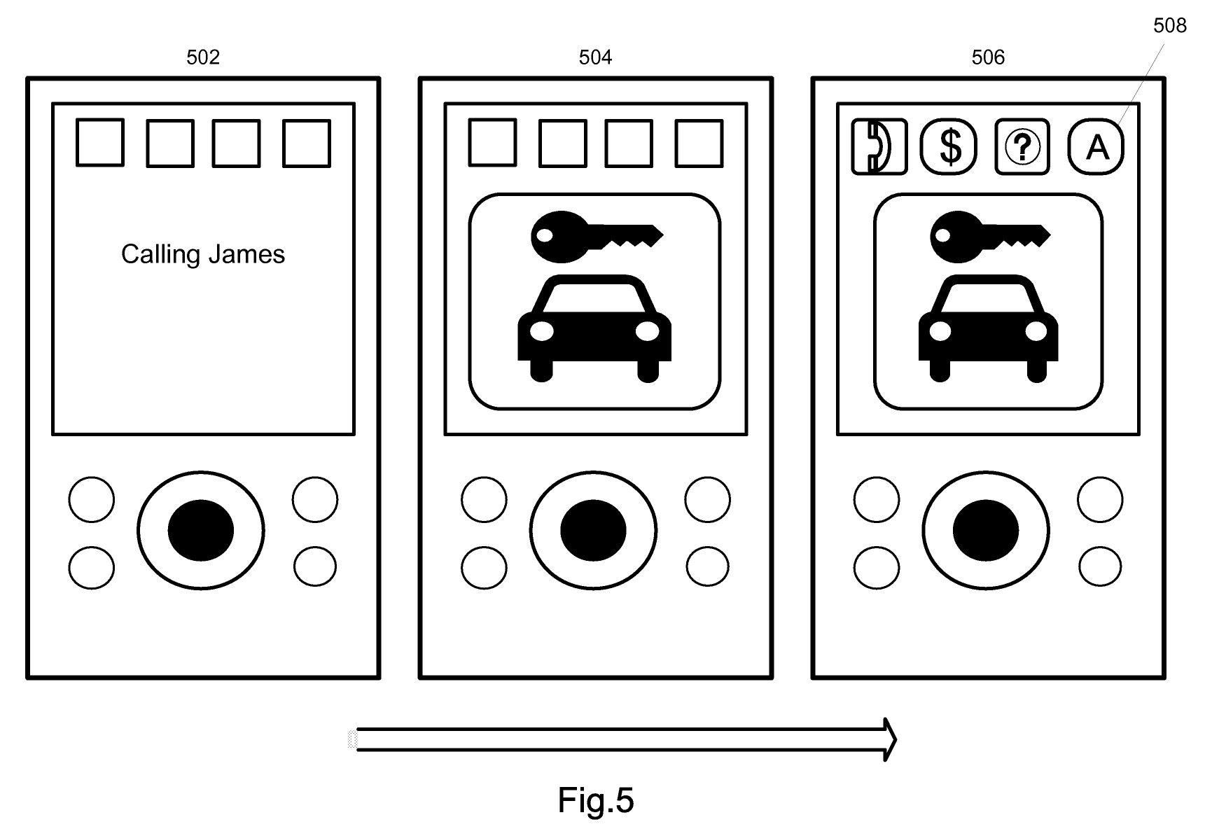

FIG. 5 is a schematic diagram of another embodiment showing a series of display screens changing from a default screen 502 for the mobile device in a calling status to a screen 504 with a displayed message and further to a screen 506 with more user selectable icons for the next level of detailed information and in particularly an icon 508 for other advertisement messages. In such an embodiment, the icon 508 provides an option for the user to navigate into a file folder containing sub-categories of other advertisement messages.

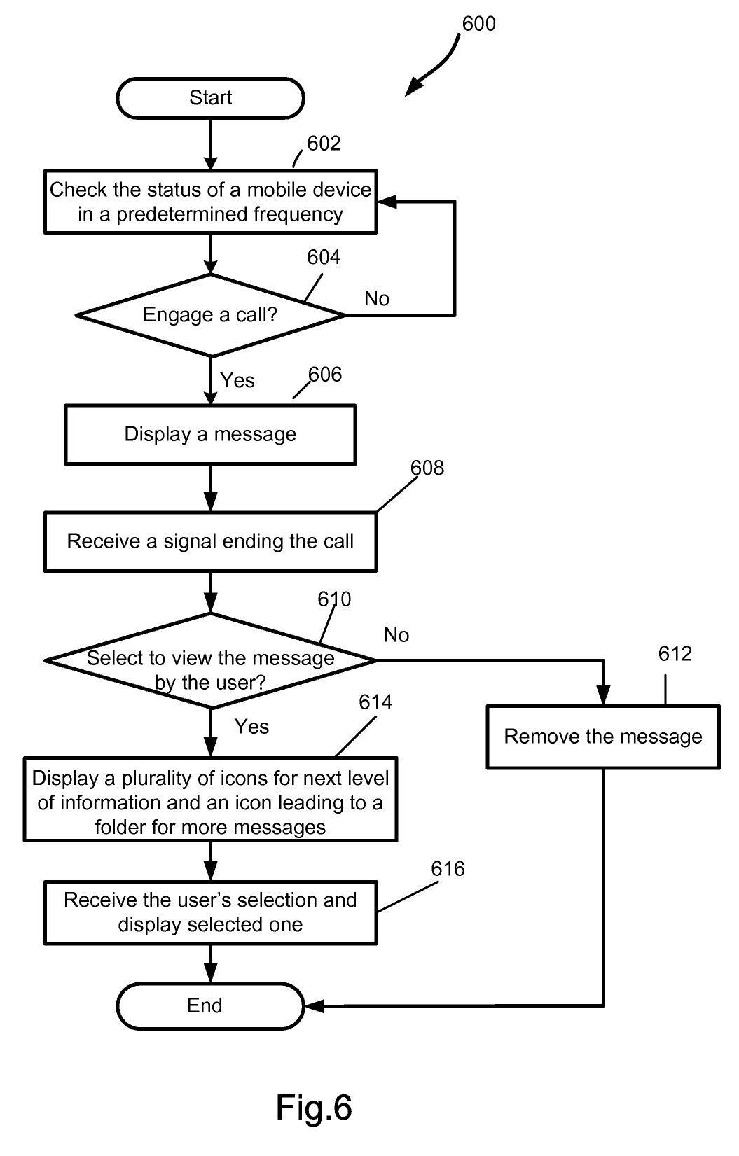

FIG. 6 is a flow diagram of the embodiment as illustrated in FIG. 5 for delivering and presenting advertisement messages to a screen of the mobile device during and after the voice communication, wherein the displayed message includes an icon for other advertisement messages. A process 600 is similar to process 400 from the step 602 to the step 612. The step 614 describes a process that a plurality of user selectable icons is presented to the user for the next level of detailed information. The step 614 includes presenting a specific icon which contains a list of other advertisement messages. It should be noted that the icon may include a user interface with multiple levels of hierarchy to organize and present other advertisement messages to the user.

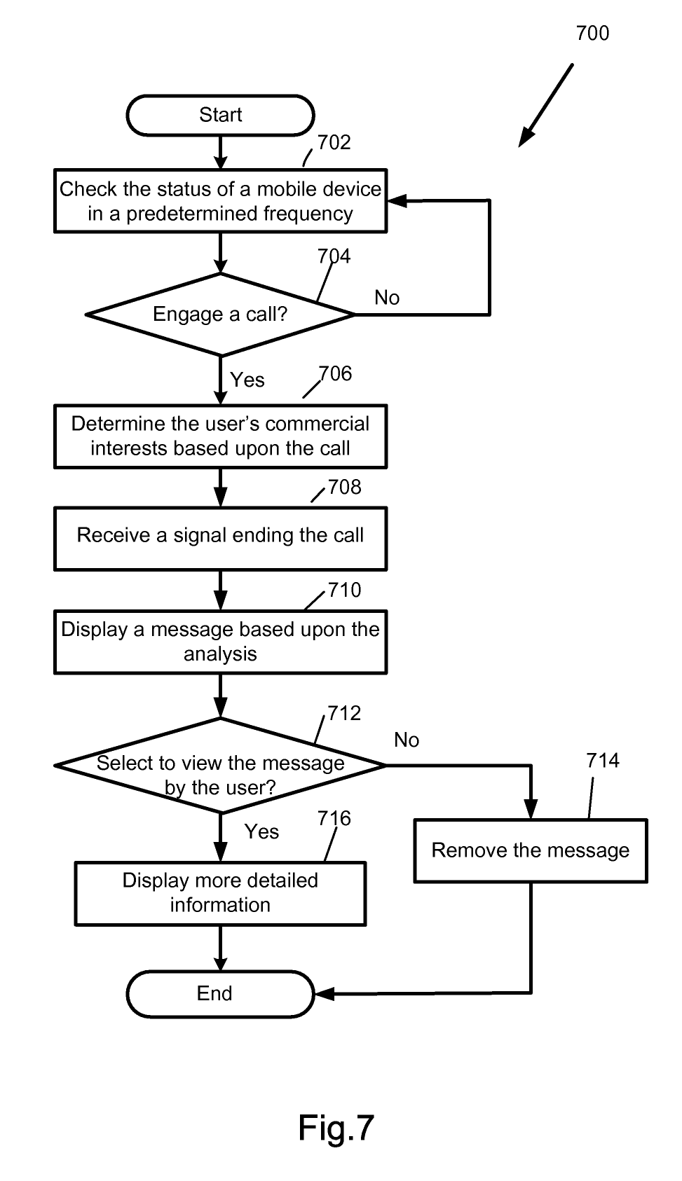

FIG. 7 is a flow diagram of still another embodiment for delivering and presenting advertisement messages to a screen of the mobile device during and after the voice communication, wherein the displayed message is determined based upon the analysis of contents of the voice communication. A process 700 starts by a step 702; the processor of the mobile device checks the device status in a predetermined frequency. If the processor detects that the device is in a “calling” status at a step 704, a voice recognition software module is used to convert the spoken words into text and a software module is used to analyze the contents of the call and to determine the user's commercial interests in a step 706. In a step 708, the call is terminated by the user and a signal associated with the ending of the call is received by the processor. An advertisement message is then displayed on the screen in a step 710 based upon the result of the analysis. The step 712 checks the user's input action. If no user's input action is received, the displayed message is deleted in a step 714 after a predetermined period of time. If the user does select the message, the next level of detailed messages is displayed in a step 716. In an alternative means, a plurality of user selectable items is displayed and the user can select at least one icon for further information.

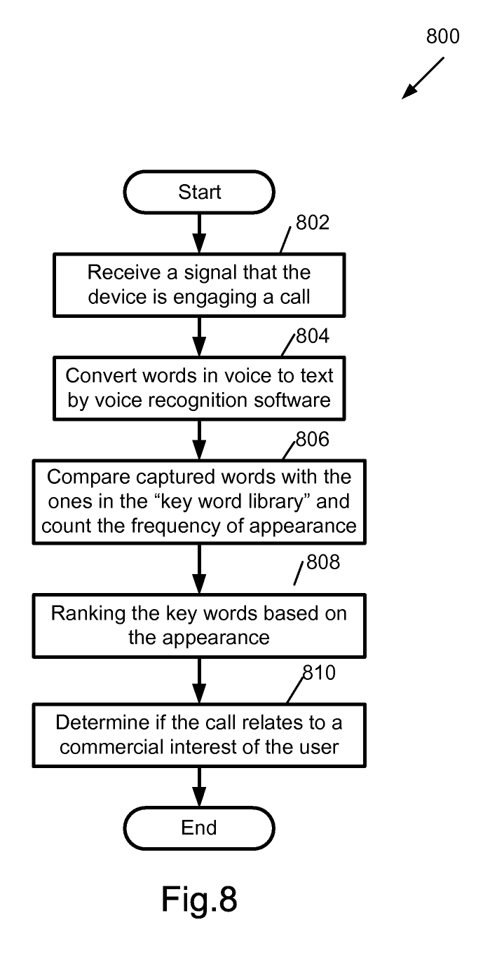

FIG. 8 is a flow diagram of a process for determining a user's commercial interests. The process 800 starts with a step 802 that the processor checks the status of the mobile device in a predetermined frequency. If a signal is received that the device is in a “calling” status, a software module is used in a step 804 to convert the words used in the voice communication into text form by employing a voice recognition software module. The recorded words are then compared to a list of words in a file. The words are selected to represent typical commercial interests of an average user. For example, the file may include words such as, for example, restaurants, bars, theaters, clubs, cars, vacation destination etc. Further, the file may include names of local restaurants, bars and brand names of cars and other merchant items. The captured words from the voice communication are compared with the words in the file in a step 806. A successful match is counted as a successful event. The successful events are counted and ranked for the words. The top ranked words are used to determine the commercial interest of the user in a step 808. The message is then displayed based upon the commercial interests determined by the analyzing of the content of the voice communication. It should be noted that not every voice communication can indicate a commercial interest of the user. As a supplementary means, the user's personal profile and the user's location determined by a GPS device integrated with the mobile device can be used to help to generate a targeted advertisement messages together with the method of the “key word analyzer”.

1. A method of rendering one or a plurality of advertisement messages to a user using a mobile device terminal, the method comprising:
receiving a signal that said mobile device is being used for a voice communication and;
displaying at least one said advertisement message and;
receiving said user's input action terminating said voice communication.

2. The method as recited in claim 1, wherein said method further comprising:
receiving the user's further input action that selects the displayed message for a review and;
displaying more information and/or more user selectable items for more information and;
receiving said user's input action for selecting at least one said item for more information.

3. The method as recited in claim 1, wherein said method further comprising of deleting the displayed message if said user's input action that selects the displayed message for the review is not received after a predetermined period of time of terminating the voice communication.

4. The method as recited in claim 1, wherein said mobile device including:
a processor that controls operations of device and;
a communication unit that communicates with other devices or servers through a communication network and;
a file storage system that stores data files and;
a display screen that displays a content and;
a user input device that receives the user's input actions.

5. The method as recited in claim 1, wherein said mobile device further including a Global Positioning System (GPS) that determines the position of said mobile device carried by said user.

6. The method as recited in claim 1, wherein operations of rendering said messages to said user are managed by a software module of said mobile device.

7. The method as recited in claim 1, wherein said messages including text messages, graphic messages and video messages.

8. A method of rendering one or a plurality of advertisement messages to a user using a mobile device terminal, the method comprising:
receiving a signal that said mobile device is being used for a voice communication and;
analyzing contents of said voice communication and;
receiving said user's input action terminating said voice communication and;
displaying a message according to results of analyzing contents.

9. The method as recited in claim 8, wherein said method further comprising:
receiving the user's further input action that selects the displayed message for a review and;
displaying more information and/or more user selectable items for more information and;
receiving said user's input action for selecting at least one said item for more information.

10. The method as recited in claim 8, wherein said mobile device including:
a processor that controls operations of device and;
a communication unit that communicates with other devices or servers through a communication network and;
a file storage system that stores data files and;
a display screen that displays a content and;
a user input device that receives the user's input actions.

11. The method as recited in claim 8, wherein said mobile device further including a Global Positioning System (GPS) that determines the position of said mobile device carried by said user.

12. The method as recited in claim 8, wherein said message including one based upon combined results of analyzing the contents of said voice communication and identifying the location of the mobile device.

13. The method as recited in claim 8, wherein said message including one based upon combined results of analyzing the contents of said voice communication and identifying the location of the mobile device and other information related to said user's commercial interests.

14. The method as recited in claim 8, wherein said method further comprising of deleting the displayed message if said user's input action that selects the displayed message for the review is not received after a predetermined period of time of terminating the voice communication.

15. The method as recited in claim 8, wherein said messages including text messages, graphic messages, video messages, audio messages and/or multi-media messages.

16. A method of identifying a user's commercial interests by a means of analyzing contents of the user's voice communication, the method comprising:
comparing words in said voice communication with words in a file and;
identifying a match between one word from said voice communication and one word from said file as one successful event and;
counting and ranking said successful events for said words from said voice communication.

17. The method as recited in claim 16, wherein said method further comprising a means determining said user's commercial interests based up said top ranked words.

18. The method as recited in claim 16, wherein said operation of comparing is conducted including a means of converting said words into text forms by using of voice-recognition software.

19. The method as recited in claim 16, wherein said file including a list of words representing various groups of merchandisers.

20. The method as recited in claim 16, wherein said file including a list of words representing names of merchandisers.
